(19) United States
(12) Patent Application Publication
(10) Pub. No.: US 2016/0300157 A1
(43) Pub. Date: Oct. 13, 2016

(54) LambdaLib: In-Memory View Management and Query Processing Library for Realizing Portable, Real-Time Big Data Applications

(71) Applicant: NEC Laboratories America, Inc., Princeton, NJ (US)

(72) Inventors: Murugan Sankaradas, Dayton, NJ (US); Giuseppe Coviello, Plainsboro, NJ (US); Srimat Chakradhar, Manalapan, NJ (US); Marco Gianfico, Sant'Antimo (NA) (IT); Emanuel Di Nardo, Mondragone (CE) (IT)

(21) Appl. No.: 15/089,667

(22) Filed: Apr. 4, 2016

Related U.S. Application Data
(60) Provisional application No. 62/144,621, filed on Apr. 8, 2015.

(51) Int. Cl. G06N 99/00; G06F 17/30

(52) U.S. Cl. CPC G06N 99/005; G06F 17/30516; G06F 17/3056

(57) ABSTRACT

A big data processing system includes a memory management engine having stream buffers, realtime views and models, and batch views and models, the stream buffers coupleable to one or more stream processing frameworks to process stream data, the batch models coupleable to one or more batch processing frameworks; one or more processing engines including Join, Group, Filter, Aggregate, Project functional units and classifiers; and a client layer engine communicating with one or more big data applications, the client layer engine handling an output layer, an API layer, and an unified query layer.

This application claims priority to Provisional Application 62/144,621, filed Apr. 8, 2015, the content of which is incorporated by reference.

### BACKGROUND

The present invention relates to systems and methods for big data databases.

Our computing world is currently going through change from batch based data processing to real-time data processing. Even though the progress is made from multiple fronts, it is a monumental challenge to process voluminous amount of data in real-time. Current generation of developers and technologists can choose from wide variety of tools to create a complete data processing system, but it is a great challenge to choose between right set of tools, incorporate them, orchestrate between them. As fast incoming data creates “big data”, applications need to capture value on the incoming data using real-time analytics, using both past historical data and data that are streaming to the system. Modern big data applications' need for both batch processing and stream processing creates problems like fault tolerance, latency and throughput. Even though problems are addressed by Lambda Architecture, it is a great challenge for application developer point of view to write modules to interface with different batch or streaming systems, real-time or batch databases, query interfaces, for example.

Lambdoop is a software abstraction layer over Open source Apache technologies like Hadoop, Hbase, Sqoop, Flume, and Storm for realizing Lambda architectures. It allows users to write their applications in commonly used patterns and operations (for e.g. Aggregation, filtering, statistics etc.). It is harder to write application code with minimum of set of patters and operations. Even though Lambdoop abstracts the systems framework, memory management problem still remains. No query support for common query languages exists either.

One existing approach, Summingbird, is a library that lets one to write MapReduce programs and execute them on a number of well-known distributed batch or streaming platforms. User execute the Summingbird program in “batch mode” (for e.g. using Scalding), in “real-time mode” (for e.g. using Storm), or on both Scalding and Storm in a hybrid batch/real-time mode (Lambda architecture mode) that offers an application very attractive fault-tolerance properties. Summingbird doesn't provide any value beyond code reuse across batch, real-time, hybrid modes. It doesn't have any query support and doesn't have memory management support.

Another approach called Buildoop provides a tool focused in the building of the Lambda Architecture ecosystem. It is based on Groovy and JSON for recipe definitions. It can be used to build systems based on Lambda Architecture, but it doesn't have any way to support various classes of queries like SQL, graph, GIS etc. Buildoop provides ways to configure various big data components using recipe definitions, but doesn't do memory management function or processing functions.

### SUMMARY

In one aspect, a big data processing system includes a memory management engine having stream buffers, real-time views and models, and batch views and models, the stream buffers coupleable to one or more stream processing frameworks to process stream data, eh batch models coupleable to one or more batch processing frameworks; one or more processing engines including Join, Group, Filter, Aggregate, Project functional units and classifiers; and a client layer engine communicating with one or more big data applications, the client layer engine handling an output layer, an API layer, and an unified query layer.

Advantages of the system may include one or more of the following. The system makes it easier to write real-time streaming big data applications. It is a reusable library component which performs various complex functions like memory management, extendible processing units and unified client layer. It makes the big data applications portable across various big data platforms. It aids big data application developers to create fault tolerant, low latency and high throughput applications quickly. The system makes the big data applications portable to any big data framework. The system works with different stream processing and batch processing frameworks under the hood. Users need not write the application targeting a particular big data platform. Applications don't have to worry about intricacies of big data framework. They interact with the big data systems using simple APIs provided by unified API layer of the system. Storage of input data, views and models are automatically managed by memory management unit of the system. User has to provide under which mode the system has to operate and the size required. The system automatically takes care of storage management. Access to big data systems using standard query functions like SQL, CQL and Graph, is enabled by unified query Abstraction layer of the system for Lambda type big data applications. Beyond default processing units, the system provides hooks to enable users write and plugin their own custom functional units. For example users can write their

### BRIEF DESCRIPTION OF THE DRAWINGS

FIG. 1 shows an exemplary process for generating portable, real-time big data applications.

FIG. 2 shows an exemplary big data computing system.

### DESCRIPTION

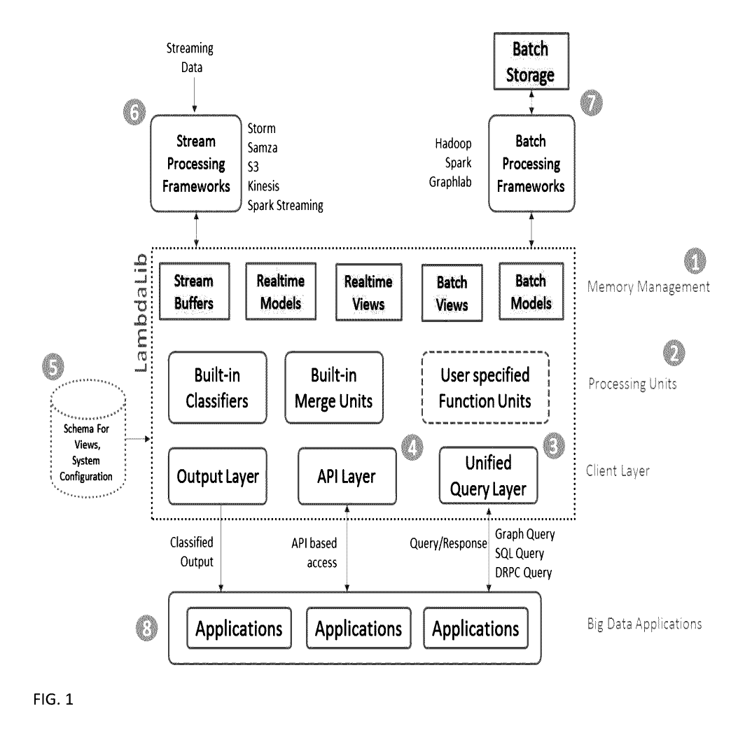

Referring now to the drawings in which like numerals represent the same or similar elements and initially to FIG. 1, an exemplary method for generating portable, real-time big data applications is presented. The system, also known as LambdaLib, aims to solve the problems associated with realizing real-time big data architectures by providing memory management, commonly used functional units, unified query layer, simple API access. LambdaLib is a reusable component which can be used across variety of streaming big data applications in the areas of IoT, smart grid, video surveillance, smart city, social media analytics, among others.

Turning now to FIG. 1, Block 1 is a Memory Management unit. Various contexts of the application may have to be stored in memory. How and where it is stored depends on the nature of data, source of data, sink of data, for example. Data can be materialized view from batch or streaming layer which may be used again and again. It can be models obtained from learning behavior of streaming data or batch data. It can just be raw data snapshot streaming from the input. Based on data requirements, it has to be stored in time window fashion in hash-table or time series database or in-memory database. Memory management unit abstracts the storage of data to the end user. User specifies the type of data base, size, access mechanism, location, windowing scheme, window size, time to live etc. Memory management unit manages the data based on the configuration specified. Block 2 represents Processing Units in the system. The system contains actions which process the data. Input to the actions can be streaming input data or historical input data or pre-processed views. Some of the type functional units are Join, Group, Filter, Aggregate, Project. It also has built-in classifiers. It also allows functional hooks, so the users can plug in their own custom processing units to process the data. Block 3 represents a Unified Query Layer. Different applications have different computational, data access needs based on legacy, user knowledge, portability etc. Hence the applications may be optimized for a specific query language like SQL, CQL, Graph or GIS etc. Unified query layer in LambdaLib allows applications to use variety of traditional query languages. It internally translates it to representation needed to communicate to storage layer and processing units. Block 4 is the API Layer. Users can initiate stream and batch processing, read or write to stream or batch store using LambdaLib specified API access functions. To aid the user in managing batch and real-time views, following API calls are provided updateBatch( ), updateRealTime( ), readBatch( ), readRealTime( ). updateBatch( ) allows full cycle run of the Batch routines and update the batch view or model. Readbatch( ) allows read of batch view or model( ) via output layer.

Block 5 represents the Configuration and Schemas where the user can specify the type of data base, size, access mechanism, location, windowing scheme, window size, time to live, among others. Configuration is done for real-time and batch stores to store summary/views, models and data cache. Schema for data storage can also be stored in the configuration file. Block 6 represents stream processing frameworks. Data generated by streaming applications can be seen as streams of events or tuples. Since large amount of data is generated by sensors of this class of streaming applications, information is processed by class of frameworks called Stream processing frameworks. Some examples of these frameworks include Apache Storm, Apache Samza, Kinesis, and Spark Streaming.

Block 7 represents batch processing frameworks. Batch processing frameworks process huge amount of data using large commodity clusters. As the de-facto platform for big data, Apache Hadoop allows businesses to create highly scalable and cost-efficient data stores. Organizations can then run massively parallel and high-performance analytical workloads on that data, unlocking new insight previously hidden by technical or economic limitations. Block 8 represents applications. As fast incoming data creates “big data”, applications need to capture value on the incoming data using real-time analytics, using both past historical data and data that are streaming to the system. Examples of applications include IoT applications, Smart Grid, Smart City, video surveillance, social media analytics.

The system (known as Lambdalib) makes the big data applications portable to any big data framework. Lambdalib makes it easier to write real-time streaming big data applications. It is a reusable library component which performs various complex functions like memory management, extendible processing units and unified client layer. It makes the big data applications portable across various big data platforms. It aids big data application developers to create fault tolerant, low latency and high throughput applications quickly. LambdaLib works with different stream processing and batch processing frameworks under the hood. Users don't have write the application targeting a particular big data platform. Applications don't have to worry about intricacies of big data framework. They interact with the big data systems using simple APIs provided by unified API layer of Lamdalib. Storage of input data, views and models are automatically managed by memory management unit of LambdaLib. User has to provide under which mode the LambdaLib has to operate and the size required. LambdaLib automatically takes care of storage management. Access to big data systems using standard query functions like SQL, CQL and Graph, is enabled by unified query Abstraction layer of LambdaLib for Lambda type big data applications. Beyond default processing units, LambdaLib provides hooks to enable users write and plugin their own custom functional units. For example users can write their custom merge or join or classification functions.

The system provides:
i. Application portability across various batch or real-time big data platforms
ii. Memory management unit
iii. Unified query abstraction layer
iv. Provision for custom functional units

LambdaLib makes the big data applications portable to any big data framework. LambdaLib works with different stream processing and batch processing frameworks under the hood. Users don't have write the application targeting a particular big data platform. Applications don't have to worry about intricacies of big data framework. They interact with the big data systems using simple APIs provided by unified API layer of Lamdalib. Storage of input data, views and models are automatically managed by memory management unit of LambdaLib. User has to provide under which mode the LambdaLib has to operate and the size required. LambdaLib automatically takes care of storage management. Access to big data systems using standard query functions like SQL, CQL and Graph, is enabled by unified query Abstraction layer of LambdaLib for Lambda type big data applications. Beyond default processing units, LambdaLib provides hooks to enable users write and plugin their own custom functional units.

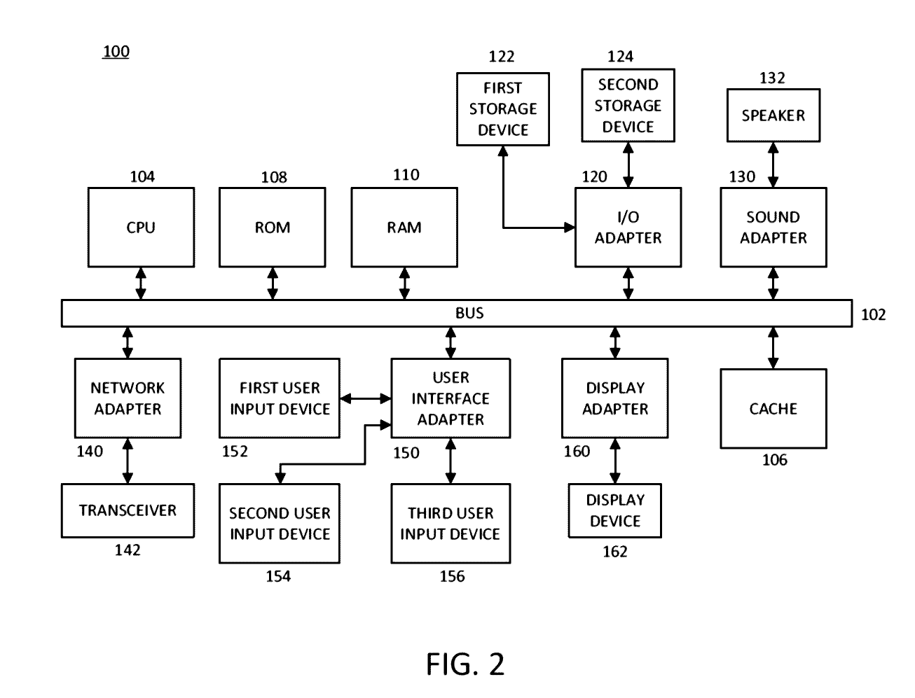

Referring now to FIG. 2, an exemplary video processing system 10, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

Further, it is to be appreciated that processing system 100 may perform at least part of the methods described herein including, for example, at least part of method of FIG. 1.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A big data processing system, comprising:
a memory management engine having stream buffers, realtime views and models, and batch views and models, the stream buffers coupleable to one or more stream processing frameworks to process stream data, eh batch models coupleable to one or more batch processing frameworks;
one or more processing engines including Join, Group, Filter, Aggregate, Project functional units and classifiers; and
a client layer engine communicating with one or more big data applications, the client layer engine handling an output layer, an API layer, and an unified query layer.

2. The system of claim 1, wherein the memory management engine processes data including a materialized view from a batch or a streaming layer.

3. The system of claim 1, comprising models generated from learning behavior of streaming data or batch data.

4. The system of claim 1, wherein the memory management engine stores data in time window fashion in a hash-table or time series database or an in-memory database

5. The system of claim 1, wherein the user specifies data base, size, access mechanism, location, windowing scheme, window size, time to live, and wherein the memory management engine manages the data based on the configuration specified.

6. The system of claim 1, comprising actions which process the data and input to the actions can be streaming input data or historical input data or pre-processed views.

7. The system of claim 1, comprising functional hooks to plug in user own custom processing units to process the data.

8. The system of claim 1, comprising a unified query layer that allows applications to use traditional query languages.

9. The system of claim 8, wherein the unified query layer internally translates query languages to representation needed to communicate to storage layer and processing units.

10. The system of claim 1, wherein the API layer API calls comprise updateBatch( ), updateRealTime( ), readBatch( ), readRealTime( ).

11. The system of claim 1, wherein the user specifies the type of data base, size, access mechanism, location, windowing scheme, window size, time to live

12. The system of claim 1, wherein configuration is done for real-time and batch stores to store summary/views, models and data cache.

13. The system of claim 1, comprising a stream processing framework to process data.

14. The system of claim 12, wherein the framework includes Apache Storm, Apache Samza, Kinesis, and Spark Streaming.

15. The system of claim 1, comprising a batch processing framework to process large data using computer clusters.

16. The system of claim 1, comprising applications coupled to the client layer engine include IoT applications, Smart Grid, Smart City, video surveillance, social media analytics.
